(19) United States
(12) Patent Application Publication
(10) Pub. No.: US 2026/0098787 A1
(43) Pub. Date: Apr. 9, 2026

(54) MISFIRE DIAGNOSIS DEVICE

(71) Applicant: SUZUKI MOTOR CORPORATION, Hamamatsu-shi (JP)

(72) Inventor: Kohei YAMAMOTO, Hamamatsu-shi (JP)

(73) Assignee: SUZUKI MOTOR CORPORATION, Hamamatsu-shi (JP)

(21) Appl. No.: 19/304,369

(22) Filed: Aug. 19, 2025

(30) Foreign Application Priority Data
Oct. 7, 2024 (JP) 2024-175941

(51) Int. Cl. G01M 15/11

(52) U.S. Cl. CPC G01M 15/11

(57) ABSTRACT

A misfire diagnosis device that diagnoses presence or absence of a misfire in an engine having a plurality of cylinders, includes: a recording unit configured to record a misfire index value indicative of a misfire state of some cylinders; a setting unit configured to set a calculation interval to a period during which at least all cylinders make one cycle of ignition; a calculation unit configured to calculate a difference between a maximum value and a minimum value of the misfire index value in the calculation interval; and a diagnosis unit configured to diagnose a misfire state when the difference in the misfire index value is equal to or greater than a threshold value.

### CROSS-REFERENCE TO RELATED APPLICATION(S)

This application is based on and claims priority under 35 USC 119 from Japanese Patent Application No. 2024-175941 filed on Oct. 7, 2024, the entire content of which is incorporated herein by reference.

### TECHNICAL FIELD

The present invention relates to an engine misfire diagnosis device.

### BACKGROUND ART

In recent years, there has been known an abnormality diagnosis device that diagnoses abnormalities in each cylinder of an engine (see, for example, Patent Literature 1). In the abnormality diagnosis device described in Patent Literature 1, a difference between an instantaneous minimum rotational speed and an instantaneous maximum rotational speed during a power stroke for each cylinder is calculated as a rotational fluctuation time difference. The rotational fluctuation time difference is calculated for each cylinder, and a rotational fluctuation deviation is calculated for each cylinder from the rotational fluctuation time difference for each cylinder and an average value of the rotational fluctuation time differences for all cylinders. The rotational fluctuation deviation is then compared with a preset threshold value to diagnose a misfire state due to insufficient combustion in each cylinder, as well as abnormalities such as insufficient fuel injection by an injector or excessive fuel injection.

### CITATION LIST

### Patent Literature

Patent Document 1: JP3861550B

However, in the abnormality diagnosis device described in Patent Literature 1, index values such as rotational speed are calculated for each ignition, and since ignition intervals are short in a multi-cylinder engine, fluctuations in the index values cannot be fully captured. This may result in an erroneous diagnosis of whether a misfire has occurred.

### SUMMARY

The present invention is made in consideration of the above-described problems, and an object of the present invention is to provide a misfire diagnosis device and a program that can accurately diagnose occurrence of a misfire in a multi-cylinder engine.

A misfire diagnosis device of an aspect of the present invention is a misfire diagnosis device that diagnoses presence or absence of a misfire in an engine having a plurality of cylinders, including: a recording unit configured to record a misfire index value indicative of a misfire state of some cylinders; a setting unit configured to set a calculation interval to a period during which at least all cylinders make one cycle of ignition; a calculation unit configured to calculate a difference between a maximum value and a minimum value of the misfire index value in the calculation interval; and a diagnosis unit configured to diagnose a misfire state when the difference in the misfire index value is equal to or greater than a threshold value.

In the misfire diagnosis device of the aspect of the present invention, the calculation interval is set for each period in which at least all the cylinders make one cycle of ignition, and the misfire state of all the cylinders is diagnosed comprehensively. By ensuring a long calculation interval and comprehensively monitoring the ignition of all cylinders, even in a multi-cylinder engine with short ignition intervals, fluctuations in the misfire index value can be adequately detected, improving diagnostic accuracy. By setting a long calculation interval, the number of calculations is reduced compared to when a misfire is diagnosed at each ignition interval, and thus a calculation load is reduced.

### BRIEF DESCRIPTION OF DRAWINGS

FIG. 1 is a functional block diagram of an engine system according to an example.

FIG. 2 is a functional block diagram of a misfire diagnosis device according to the example.

FIG. 3 is a time chart of misfire diagnosis according to the example.

FIG. 4 is a flowchart of a recording process for misfire diagnosis according to the example.

FIG. 5 is a flowchart of a calculation process for misfire diagnosis according to the example.

### DESCRIPTION OF EMBODIMENTS

A misfire diagnosis device according to an aspect of the present invention diagnoses presence or absence of a misfire in an engine having a plurality of cylinders. In the misfire diagnosis device, a recording unit records a misfire index value indicative of a misfire state of some cylinders, and a setting unit sets a calculation interval to a period during which at least all the cylinders make one cycle of ignition. A calculation unit calculates a difference between a maximum value and a minimum value of the misfire index value in the calculation interval, and a diagnosis unit diagnoses a misfire state when the difference in the misfire index value is equal to or greater than a threshold value. In this way, the calculation interval is set to correspond to a period during which at least all the cylinders make one cycle of ignition, and the misfire state of all the cylinders is diagnosed comprehensively. By ensuring a long calculation interval and comprehensively monitoring the ignition of all cylinders, even in a multi-cylinder engine with short ignition intervals, fluctuations in the misfire index value can be adequately detected, improving diagnostic accuracy. By setting a long calculation interval, the number of calculations is reduced compared to when a misfire is diagnosed at each ignition interval, and thus a calculation load is reduced.

### Example

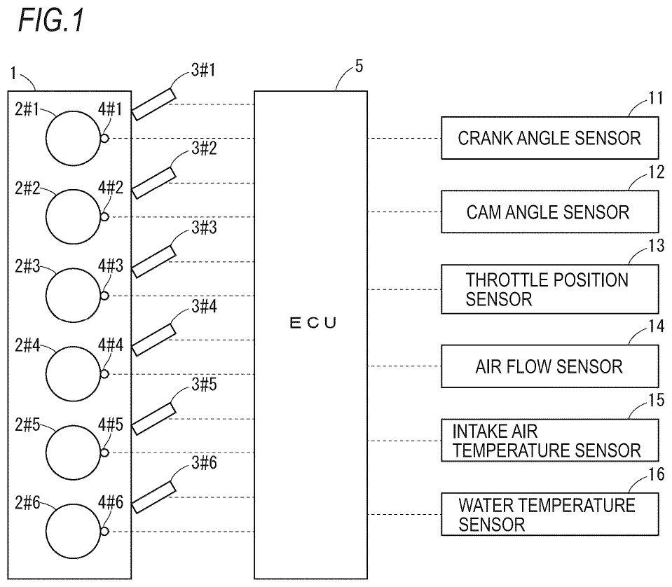

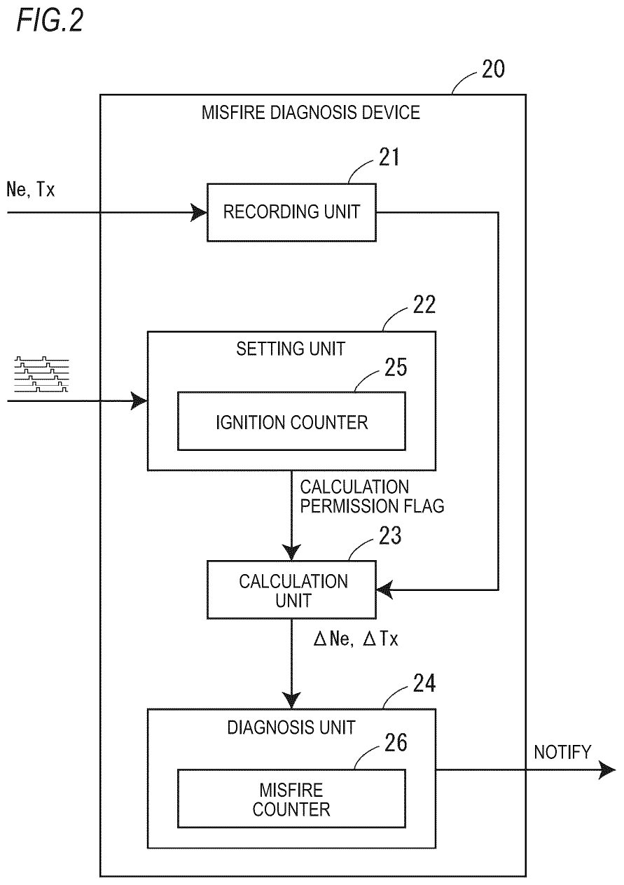

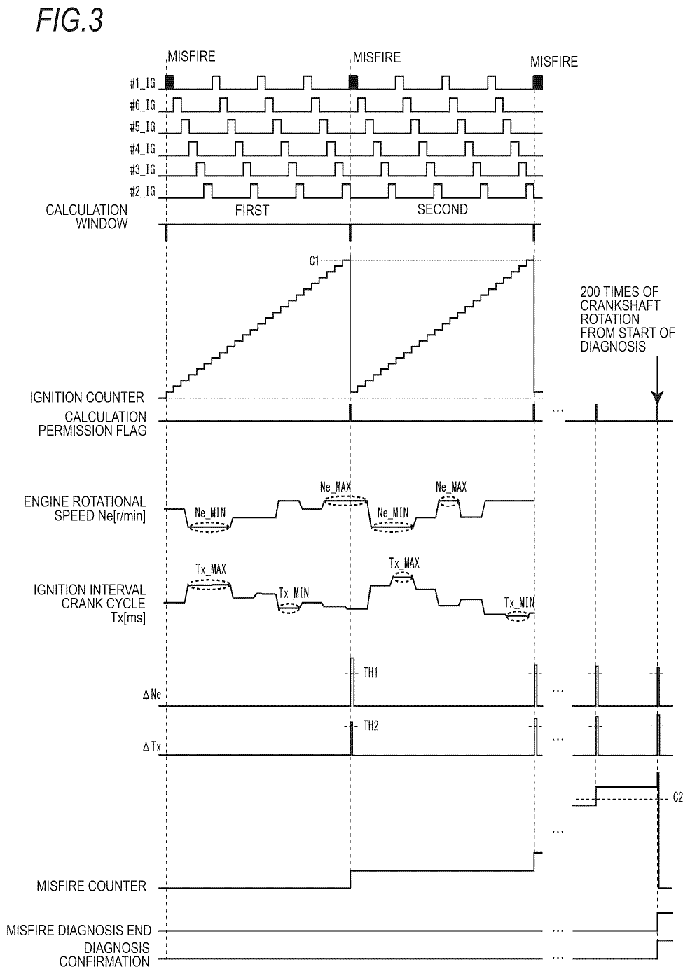

A misfire diagnosis device of the present example will be described below with reference to the accompanying drawings. FIG. 1 is a functional block diagram of an engine system according to this example. FIG. 2 is a functional block diagram of the misfire diagnosis device of this example. FIG. 3 is a time chart of misfire diagnosis in this example.

As illustrated in FIG. 1, an engine 1 is a four-stroke engine that repeats an intake stroke, a compression stroke, an expansion stroke, and an exhaust stroke. The engine 1 is formed with cylinders 2#1 to 2#6, and the respective cylinders 2#1 to 2#6 are provided with intake valves (not illustrated), exhaust valves (not illustrated), fuel injection valves 3#1 to 3#6, and spark plugs 4#1 to 4#6. An Electronic Control Unit (ECU) 5 controls fuel injection from the fuel injection valves 3#1 to 3#6 and ignition from the spark plugs 4#1 to 4#6, so that the cylinders 2#1 to 2#6 are ignited in sequence at crank angle intervals of 120°, and ignition of all cylinders is repeated periodically.

The ECU 5 is connected to a group of sensors such as a crank angle sensor 11, a cam angle sensor 12, a throttle position sensor 13, an air flow sensor 14, an intake air temperature sensor 15, a water temperature sensor 16, and the like. The crank angle sensor 11 outputs a signal corresponding to a rotation angle of a crankshaft (not illustrated), and the cam angle sensor 12 outputs a signal corresponding to a rotation angle of a camshaft (not illustrated). The throttle position sensor 13 outputs a signal corresponding to a throttle opening degree, and the air flow sensor 14 outputs a signal corresponding to the amount of intake air. The intake air temperature sensor 15 outputs a signal corresponding to an intake air temperature, and the water temperature sensor 16 outputs a signal corresponding to a cooling water temperature of the engine 1.

Based on output results of the crank angle sensor 11, the cam angle sensor 12, the throttle position sensor 13, the air flow sensor 14, the intake air temperature sensor 15, and the water temperature sensor 16, the ECU 5 determines ignition timing and performs various controls. The ECU 5 also calculates an engine rotational speed Ne in response to the signal from the crank angle sensor 11, and obtains a rotational speed of the crankshaft from the engine rotational speed Ne to calculate an ignition interval crank cycle (ignition cycle) Tx. The ignition interval crank cycle Tx is the rotation time of the crankshaft from the ignition of one cylinder to the ignition of the next cylinder, and in this example indicates the time required for the crankshaft to rotate 120°.

As illustrated in FIGS. 2 and 3, a misfire diagnosis device 20 is connected to the engine 1, which diagnoses whether the engine 1 having a plurality of cylinders has a misfire. In the misfire diagnosis device 20 of this example, the ignition of all cylinders 2#1 to 2#6 is comprehensively monitored. The misfire diagnosis device 20 includes a recording unit 21 that records misfire index values that indicate a misfire state of several cylinders, a setting unit 22 that sets a calculation interval to a period during which at least all cylinders 2#1 to 2#6 make one cycle of ignition, a calculation unit 23 that calculates a difference between a maximum value and a minimum value of the misfire index value in the calculation interval, and a diagnosis unit 24 that diagnoses a misfire state when the difference between the misfire index values is equal to or greater than a threshold value.

The recording unit 21 records the engine rotational speed Ne and the ignition interval crank cycle Tx calculated by the ECU 5 as misfire index values. When a misfire occurs in any of the cylinders 2#1 to 2#6, combustion energy decreases due to the misfire, and the engine rotational speed Ne decreases while the ignition interval crank cycle Tx becomes longer. The misfire diagnosis device 20 diagnoses whether there is a misfire in the engine 1 by utilizing the characteristics of the engine rotational speed Ne and the ignition interval crank cycle Tx. The recording unit 21 may record either the engine rotational speed Ne or the ignition interval crank cycle Tx as the misfire index value.

The setting unit 22 receives a pulse signal from the ECU 5 in accordance with the ignition timing of each of the cylinders 2#1 to 2#6. The setting unit 22 is provided with an ignition counter 25, which increments count every time an ignition occurs in each of the cylinders 2#1 to 2#6 based on the pulse signal. Counting begins after an open flag of a calculation window is set, and when the ignition counter 25 exceeds a predetermined value C1, it is returned to the first count. When the ignition counter 25 reaches a count of one, an open flag for a next calculation window is set. A counting period from when the open flag of the calculation window is set to the predetermined value C1 of the ignition counter 25 is set as the calculation interval.

In this example, the setting unit 22 sets a period during which all the cylinders 2#1 to 2#6 undergo a plurality of ignitions as the calculation interval. Specifically, 24 counts are set as the predetermined value C1 in the ignition counter 25, and the period until the ignition of all cylinders 2#1 to 2#6 goes around four times and the count reaches 24 is set as the calculation interval. It is possible to diagnose a misfire state including the case where a particular cylinder misfires only once in a plurality of times (four times). When the ignition counter 25 reaches a count of 24, the setting unit 22 sets a calculation permission flag, which indicates that the first calculation interval has elapsed.

When the calculation permission flag is set in the setting unit 22, the calculation unit 23 calculates the difference between the maximum value and the minimum value of the misfire index value in the calculation interval. That is, the misfire index value in the calculation interval until the calculation permission flag is set is monitored, the calculation unit 23 obtains the maximum value and the minimum value of the misfire index value, and further the calculation unit 23 calculates the difference between the maximum value and the minimum value of the misfire index value. A difference ΔNe between a maximum value Ne_MAX and a minimum value Ne_MIN of the engine rotational speed in the calculation interval is obtained, and a difference ΔTx between a maximum value Tx MAX and a minimum value Tx_MIN of the ignition interval crank cycle in the calculation interval is obtained.

In the diagnosis unit 24, the difference ΔNe in the engine rotational speed is compared with a first threshold value TH1 for each calculation interval, and the difference ΔTx in the ignition interval crank cycle is compared with a second threshold value TH2 for each calculation interval. When the difference ΔNe in the engine rotational speed is equal to or greater than the first threshold value TH1 and the difference ΔTx in the ignition interval crank cycle is equal to or greater than the second threshold value TH2, the diagnosis unit 24 diagnoses a misfire state. When the difference ΔNe in the engine rotational speed is less than the first threshold value TH1 and/or the difference ΔTx in the ignition interval crank cycle is less than the second threshold value TH2, the diagnosis unit 24 diagnoses that a misfire is not occurring.

As described above, the engine rotational speed Ne and the ignition interval crank cycle Tx can be recorded simultaneously, and the diagnosis unit 24 can simultaneously diagnose a combustion state of the engine 1 using different index values, thereby improving diagnostic accuracy. The diagnosis unit 24 is also provided with a misfire counter 26, which increments count each time the diagnosis unit 24 diagnoses a misfire state. Then, when the diagnosis period has elapsed, the diagnosis unit 24 performs a final diagnosis, and when the count value (the number of diagnoses in which a misfire state has been diagnosed) of the misfire counter 26 is equal to or greater than a predetermined value (predetermined number of times) C2, the diagnosis unit 24 confirms that there is a misfire in the engine 1 and issues a notification.

In this way, when the diagnosis unit 24 repeatedly diagnoses that a misfire is occurring, it is confirmed that the engine 1 is misfiring, thereby improving diagnostic accuracy. The first and second threshold values TH1, TH2 and the predetermined values C1, C2 are set to values experimentally, empirically, and theoretically obtained from past data or the like. A rotational speed of the crankshaft is set as the diagnosis period. When the rotational speed of the crankshaft reaches a predetermined rotational speed from the start of the diagnosis, the misfire counter 26 is reset. Also, the diagnosis unit 24 may diagnose a misfire state based on only one of the difference ΔNe in the engine rotational speed and the difference ΔTx in the ignition interval crank cycle.

Each control block of the misfire diagnosis device 20 may be realized by software using a processor, or may be realized by a logic circuit (hardware) formed in an integrated circuit or the like. When the processor is used, the processor reads and executes a program stored in a memory to perform various processes. As the processor, for example, a Central Processing Unit (CPU) is used. The memory is composed of one or more storage media such as a Read Only Memory (ROM) and a Random Access Memory (RAM) depending on the application.

An example of misfire diagnosis will be described below. As illustrated in FIG. 3, ignition is repeated in the order of cylinders 2#1, 2#6, 2#5, 2#4, 2#3, and 2#2. When the open flag of the calculation window is set, the number of ignitions is counted by the ignition counter 25. When the ignition counter 25 of the setting unit 22 exceeds a count of 24, the ignition counter 25 is returned from the 24th count to the 1st count and a calculation permission flag is set. Moreover, the open flag for the next calculation window is set, and the ignition counter 25 starts counting the number of ignitions again from the first count. In this manner, one calculation interval is set to 24 counts.

Further, the engine rotational speed Ne and the ignition interval crank cycle Tx are recorded by the recording unit 21. When the setting unit 22 sets the calculation permission flag, the calculation unit 23 obtains the maximum value Ne_MAX and minimum value Ne_MIN of the engine rotational speed in a first calculation window (calculation interval), and obtains the maximum value Tx MAX and minimum value Tx_MIN of the ignition interval crank cycle. Furthermore, the calculation unit 23 obtains the difference ΔNe in the engine rotational speed and the difference ΔTx in the ignition interval crank cycle. The calculation process of the calculation unit 23 is repeatedly performed every time the calculation permission flag is set.

The difference ΔNe in the engine rotational speed is equal to or greater than the first threshold value TH1, and the difference ΔTx in the ignition interval crank cycle is equal to or greater than the second threshold value TH2. Therefore, in the first calculation window, the diagnosis unit 24 diagnoses a misfire state and the misfire counter 26 counts up by one. The calculation window is opened and the above process is repeated for each calculation interval, and the misfire counter 26 performs counting. The diagnosis period is set to be from the start of diagnosis until the crankshaft has rotated 200 times. At the end of the diagnosis period, the misfire counter 26 exceeds the predetermined value C2, so that the diagnosis unit 24 confirms that a misfire has occurred in the engine 1 and issues a notification.

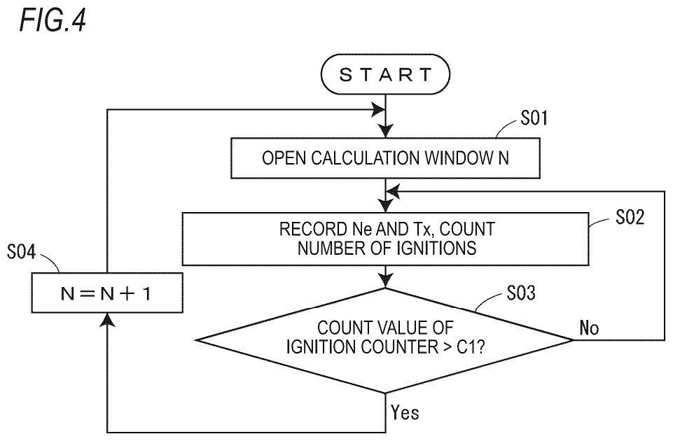

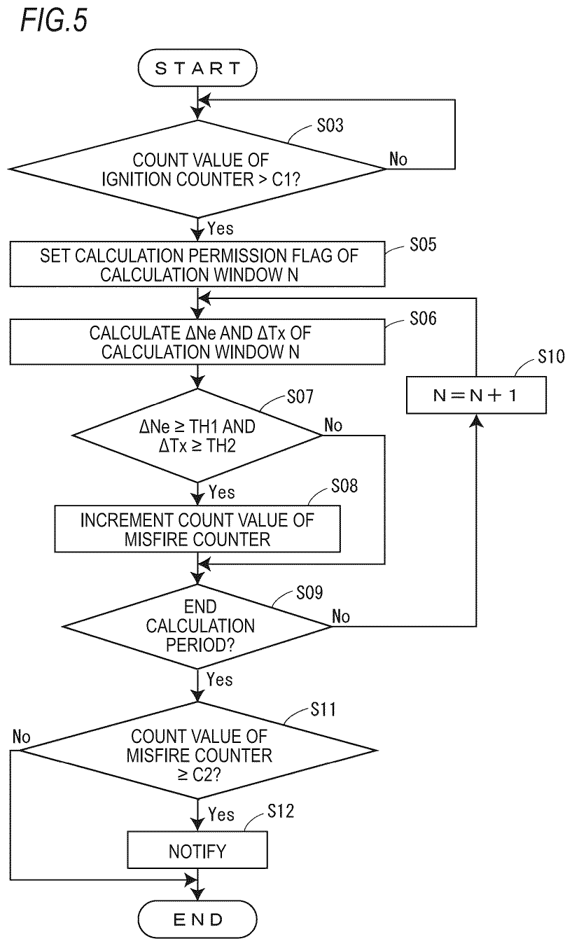

A flow of misfire diagnosis will be described with reference to FIGS. 4 and 5. FIG. 4 is a flowchart of a recording process for misfire diagnosis in this example. FIG. 5 is a flowchart of a calculation process for misfire diagnosis in this example.

As illustrated in FIG. 4, when an Nth calculation window N is opened (step S01), the number of ignitions is counted by the ignition counter 25, and the engine rotational speed Ne and the ignition interval crank cycle Tx are recorded (step S02). The process of step S02 is repeated until the count value of the ignition counter 25 exceeds the predetermined value C1 (No in step S03). When the count value of the ignition counter 25 exceeds the predetermined value C1 (Yes in step S03), an (N+1)th calculation window N+1 is opened and the process is restarted from step S01 (step S04). The calculation process for the calculation window N is carried out in parallel with the recording process for the calculation window N+1. The recording process may be stopped at the end of the diagnosis period.

As illustrated in FIG. 5, when the count value of the ignition counter 25 exceeds the predetermined value C1 (Yes in step S03), the calculation permission flag for the calculation window N is set (step S05). In the calculation window N (calculation interval N), the difference ΔNe between the maximum value Ne_MAX and the minimum value Ne_MIN of the engine rotational speed and the difference ΔTx between the maximum value Tx MAX and the minimum value Tx_MIN of the ignition interval crank cycle are obtained (step S06). When the difference ΔNe in the engine rotational speed is equal to or greater than the first threshold value TH1 and the difference ΔTx in the ignition interval crank cycle is equal to or greater than the second threshold value TH2 (Yes in step S07), the count value of the misfire counter 26 is incremented (step S08). When the diagnosis period for the misfire diagnosis has not ended (No in step S09), the process returns to step S06 and the calculation process for the calculation window N+1 is performed (step S10).

When the diagnosis period for the misfire diagnosis ends (Yes in step S09), the count value of the misfire counter 26 is compared with the predetermined value C2 (step S11). When the count value of the misfire counter 26 is equal to or greater than the predetermined value C2 (Yes in step S11), it is confirmed that a misfire has occurred in the engine 1, and a user is notified of the misfire (step S12). The method of notification is not particularly limited, but may be an error message, a mechanical voice, a warning sound, or a warning lamp. Also, even before the end of the diagnosis period, notification of the misfire may be issued when the count value of the misfire counter 26 reaches or exceeds the predetermined value C2.

In steps S02, S06, and S07, the engine rotational speed Ne and the ignition interval crank cycle Tx are used as the misfire index value, but either the engine rotational speed Ne or the ignition interval crank cycle Tx may be used as the misfire index value. The predetermined value C1 in step S03 may be set to a value (for example, 6 counts) at which all cylinders make one cycle of ignition, or may be set to a value (for example, 24 counts) at which ignition of all cylinders is repeated a plurality of times. Although a misfire is diagnosed based on a comparison result of step S11, a misfire may also be diagnosed based on a comparison result of step S07. That is, steps S08 to S11 may be omitted.

As described above, with the misfire diagnosis device 20 of this example, the misfire state of all the cylinders 2#1 to 2#6 is diagnosed comprehensively by issuing an ignition command to all the cylinders 2#1 to 2#6. By ensuring a long calculation interval and comprehensively monitoring the ignition of all cylinders 2#1 to 2#6, even in a multi-cylinder engine with a short ignition interval, the fluctuations in the engine rotational speed Ne and the ignition interval crank cycle Tx as misfire index values can be adequately detected, improving the diagnostic accuracy. By setting a long calculation interval, the number of calculations is reduced compared to when a misfire is diagnosed at each ignition interval, and thus a calculation load is reduced.

In this example, the engine rotational speed and the ignition interval crank cycle are exemplified as the misfire index value, but the misfire index value is not particularly limited as long as it is an index value that indicates a misfire state.

In addition, in this example, a six-cylinder engine is exemplified as the engine, but the engine is not particularly limited as long as it has a plurality of cylinders.

Furthermore, the ECU may function as the misfire diagnosis device, or the misfire diagnosis device may be provided separately from the ECU.

Also, a misfire diagnosis function may be added by installing a program in the ECU. This program may be stored in a storage medium. The storage medium is not particularly limited, and may be a non-transitory storage medium such as an optical disk, a magneto-optical disk, or a flash memory.

Furthermore, the misfire diagnosis device of this example is not limited to being applied to engines of outboard motors, but may be applied to engines of other vehicles.

As described above, a first aspect is a misfire diagnosis device (20) that diagnoses presence or absence of a misfire in an engine (1) having a plurality of cylinders (2#1 to 2#6), and includes a recording unit (21) that records a misfire index value indicative of a misfire state of some cylinders, a setting unit (22) that sets a calculation interval to a period during which at least all cylinders make one cycle of ignition, a calculation unit (23) that calculates a difference between a maximum value and a minimum value of the misfire index value in the calculation interval, and a diagnosis unit (24) that diagnoses a misfire state when the difference in the misfire index value is equal to or greater than a threshold value. According to this configuration, the calculation interval is set to correspond to a period during which at least all the cylinders make one cycle of ignition, and the misfire state of all the cylinders is diagnosed comprehensively. By ensuring a long calculation interval and comprehensively monitoring the ignition of all cylinders, even in a multi-cylinder engine with short ignition intervals, fluctuations in the misfire index value can be adequately detected, improving diagnostic accuracy. By setting a long calculation interval, the number of calculations is reduced compared to when a misfire is diagnosed at each ignition interval, and thus a calculation load is reduced.

In a second aspect, in the first aspect, the setting unit sets the calculation interval to a period during which ignition of all cylinders is repeated a plurality of times. According to this configuration, it is possible to diagnose a misfire state including the case where a particular cylinder misfires only once in a plurality of times.

In a third aspect, in the first or second aspect, the recording unit records an engine rotational speed (Ne) or an ignition cycle (ignition interval crank cycle Tx) as the misfire index value. According to this configuration, the presence or absence of a misfire is diagnosed by utilizing the fact that a misfire reduces combustion energy, causing the engine rotational speed to drop and the ignition cycle to become longer.

In a fourth aspect, in any one of the first to third aspects, the recording unit records the engine rotational speed and the ignition cycle as the misfire index value, the calculation unit calculates a difference between a maximum value and a minimum value of the engine rotational speed and a difference between a maximum value and a minimum value of the ignition cycle within the calculation interval, and the diagnosis unit diagnoses a misfire state when the difference in the engine rotational speed is equal to or greater than a first threshold value (TH1) and the difference in the ignition cycle is equal to or greater than a second threshold value (TH2). According to this configuration, the presence or absence of a misfire is diagnosed by utilizing the fact that a misfire reduces combustion energy, causing the engine rotational speed to drop and the ignition cycle to become longer. In addition, the engine rotational speed and the ignition interval can be recorded simultaneously, and the engine combustion state can be diagnosed using different index values at the same time, thereby improving diagnostic accuracy.

In a fifth aspect, in any one of the first to fourth aspects, the diagnosis unit confirms that a misfire occurs when the number of diagnoses of a misfire state is equal to or greater than a predetermined number of times (predetermined value C2) at the time when a diagnosis period elapses. According to this configuration, when a misfire state is repeatedly diagnosed, it is confirmed that the engine is misfiring, thereby improving diagnostic accuracy.

A sixth aspect is a program for a misfire diagnosis device that diagnoses presence or absence of a misfire in an engine having a plurality of cylinders, the program causing the misfire diagnosis device to execute the steps of recording a misfire index value indicative of a misfire state of some cylinders, setting a calculation interval to a period during which at least all cylinders make one cycle of ignition, calculating a difference between a maximum value and a minimum value of the misfire index value in the calculation interval, and diagnosing a misfire state when the difference in the misfire index value is equal to or greater than a threshold value. According to this configuration, by installing the program in an engine control device or the like, the control device or the like can be used as the misfire diagnosis device.

Although the present example is described, other examples may be made by combining the above-described example and modification examples in whole or in part.

Furthermore, the technology of the present invention is not limited to the above-described example, and may be modified, substituted, or changed in various ways without departing from the spirit and scope of the technical concept. Furthermore, when technological advances or derived technologies allow the technical ideas to be realized in a different way, they may be implemented using that method. Therefore, the claims cover all embodiments that may fall within the scope of the technical concept.

1. A misfire diagnosis device that diagnoses presence or absence of a misfire in an engine having a plurality of cylinders, comprising:
a recording unit configured to record a misfire index value indicative of a misfire state of some cylinders;
a setting unit configured to set a calculation interval to a period during which at least all cylinders make one cycle of ignition;
a calculation unit configured to calculate a difference between a maximum value and a minimum value of the misfire index value in the calculation interval; and
a diagnosis unit configured to diagnose a misfire state when the difference in the misfire index value is equal to or greater than a threshold value.

2. The misfire diagnosis device according to claim 1, wherein the setting unit sets the calculation interval to a period during which ignition of all cylinders is repeated a plurality of times.

3. The misfire diagnosis device according to claim 1, wherein the recording unit records an engine rotational speed or an ignition cycle as the misfire index value.

4. The misfire diagnosis device according to claim 1, wherein
the recording unit records an engine rotational speed and an ignition cycle as the misfire index value,
the calculation unit calculates a difference between a maximum value and a minimum value of the engine rotational speed and a difference between a maximum value and a minimum value of the ignition cycle within the calculation interval, and
the diagnosis unit diagnoses a misfire state when the difference in the engine rotational speed is equal to or greater than a first threshold value and the difference in the ignition cycle is equal to or greater than a second threshold value.

5. The misfire diagnosis device according to claim 1, wherein the diagnosis unit confirms that a misfire occurs when the number of diagnoses of a misfire state is equal to or greater than a predetermined number of times at the time when a diagnosis period elapses.

6. A non-transitory storage medium storing a program for a misfire diagnosis device that diagnoses presence or absence of a misfire in an engine having a plurality of cylinders, the program causing at least one processor to execute procedures comprising:
recording a misfire index value indicative of a misfire state of some cylinders;
setting a calculation interval to a period during which at least all cylinders make one cycle of ignition;
calculating a difference between a maximum value and a minimum value of the misfire index value in the calculation interval; and
diagnosing a misfire state when the difference in the misfire index value is equal to or greater than a threshold value.
